(19) United States
(12) Patent Application Publication
(10) Pub. No.: US 2014/0215723 A1
(43) Pub. Date: Aug. 7, 2014

(54) ADAPTER MATTRESS FOR DENTAL CHAIRS

(71) Applicant: Danilo Bacchiocchi, Castelfidardo (AN) (IT)

(72) Inventor: Danilo Bacchiocchi, Castelfidardo (AN) (IT)

(21) Appl. No.: 14/343,556

(22) PCT Filed: Sep. 13, 2011
(86) PCT No.: PCT/IT2011/000314

§ 371 Date: Mar. 7, 2014

(51) Int. Cl. A61G 15/12

(52) U.S. Cl. CPC A61G 15/12
USPC 5/690

(57) ABSTRACT

An adapter mattress for a dental chair is disclosed, comprising a flat upper surface and a lower surface with a suitably curved profile to adapt to the curvature of a dental chair, so that the upper surface of the mattress is disposed according to a horizontal plane, converting the dental chair into a surgery couch.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to an adapter mattress for dental chairs.

2. Description of Related Art Including Information Disclosed Under 37 CFR 1.97 and 37 CFR 1.98

Dentist's surgeries make large use of dental chairs connected to a dental drill unit that controls operation of dental chair.

FIG. 4 shows a dental chair (100) connected to a dental drill unit (200).

Dental chair (100) comprises:
first portion (101) where legs rest, called leg rest;
second portion (102) where buttocks rest, called seat; and
third portion (103) where back rests, called back rest.

Leg rest (101) is coupled with seat (102) and joined by means of curved connection portion (104). Leg rest (101) is disposed according to a plane that is substantially hotizontally or slightly inclined downwards. Seat (102) is inclined downwards with respect to leg rest (101). So between leg rest (101) and seat (102) an obtuse angle (α) of approximately 140°-160° is defined.

Back rest (101) is articulated with respect to seat (102). Back rest (103) can be inclined upwards with respect to seat (102) by an angle (β) from 180° to 90° according to the operator's needs. So, between seat (102) and back rest (103) a curved recessed portion (105) is defined. Generally, during surgical sessions, the angle (β) is regulated substantially equal to angle (α). Therefore, the upper part of dental chair (100) comprises a concave recessed part (105) separating seat (102) from back rest (103) and convex upward-protruding part. (104) connecting leg rest (101) to seat (102).

The dental drill unit (200) controls the height of seat (102), inclination of back rest (103) and comprises various functions, such as delivery of water, compressed air and electricity to power scyalitic lamps and other dental tools.

In any case, upper surface of leg rest (101), seat (102) and back rest (103) is ergonomic and suitably curved and shaped to follow the configuration of the patient's body.

Such a type of dental chair is impaired by some drawbacks, being not versatile and not suitable to patient's treatments other than dental ones.

Following to dental treatment, patients often need surgical, dermatological, osteopathic, massotherapy and similar treatments. Evidently, such treatments cannot be carried out on a dental chair. Consequently, patients are obliged to abandon the dentist's surgery and more to another room provided with surgical couch provided with perfectly horizontal patient's support surface.

### BRIEF SUMMARY OF THE INVENTION

The purpose of the present invention is to eliminate the drawbacks of the prior art, by disclosing an adapter mattress for dental chairs that is practical, versatile, easy to use inexpensive and simple to make.

These purposes have been achieved according, to the invention, with characteristics claimed in independent claim 1.

Advantageous embodiments appear from the dependent claims.

The adapter mattress for dental chairs of the invention comprises flat upper surface and lower upper surface with suitably curved profile in order to adapt to curvature of dental chair, so that upper surface of mattress is disposed according to a horizontal plane, converting the dental chair into a surgery couch.

The advantages of the invention are clear, it being able to convert, a dental chair into a surgical couch rapidly, simply and safely.

### BRIEF DESCRIPTION OF THE DRAWINGS

Further characteristics of the invention will appear more evident from the detailed description below, which refers to a merely illustrative, not limiting, embodiment, as shown in the attached drawings, wherein:

FIG. 1 is a perspective view of the adapter mattress of the invention disposed on a dental chair,

FIG. 2 is a perspective top view of the adapter mattress of FIG. 1;

FIG. 3 is a perspective view of the adapter mattress of FIG. 2, disposed on one side;

FIG. 4 is a perspective view of a dental chair according to prior art.

### DETAILED DESCRIPTION OF THE INVENTION

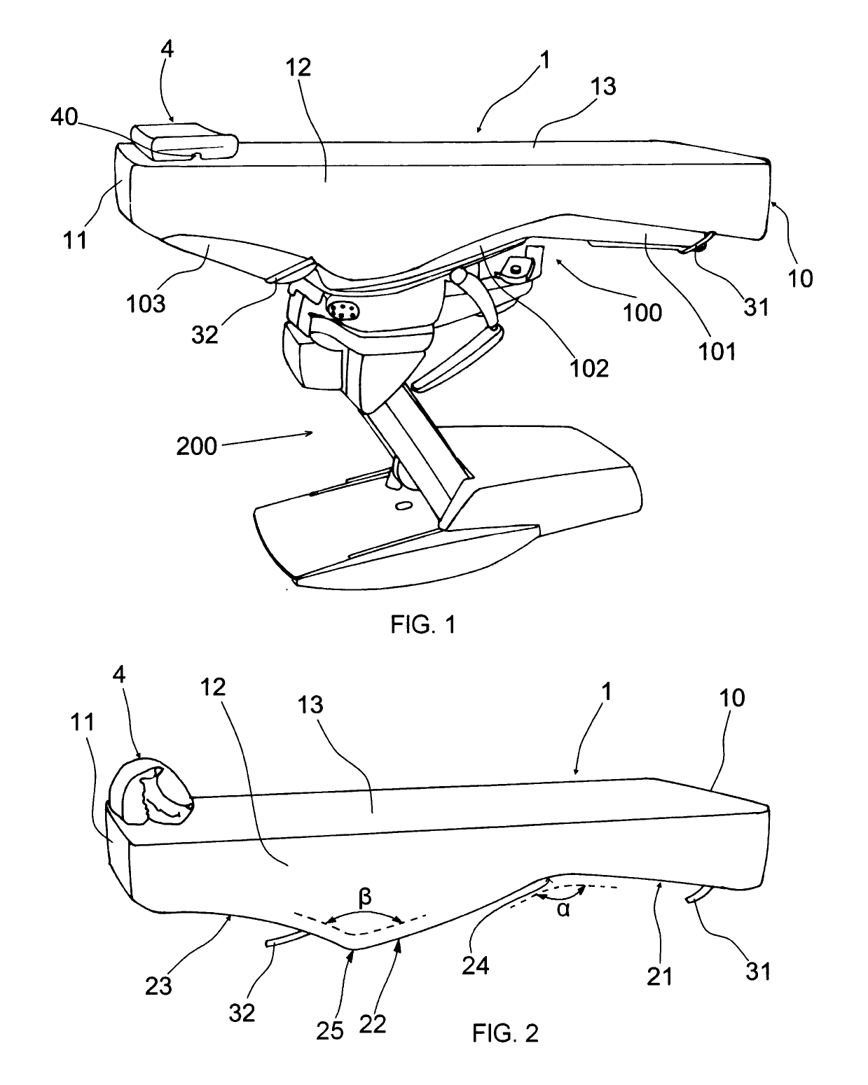

Referring to FIGS. 1 to 3, the adapter mattress of the invention is disclosed, being generally indicated with numeral (1).

Hereafter parts of dental chair (100) that have been already described are indicated with same numerals, omitting a detailed description.

The adapter mattress (1) has a basically parallelepiped shape and comprises first transversal border (10) in correspondence of feet, second transversal border (11) in correspondence of head and two lateral borders (12).

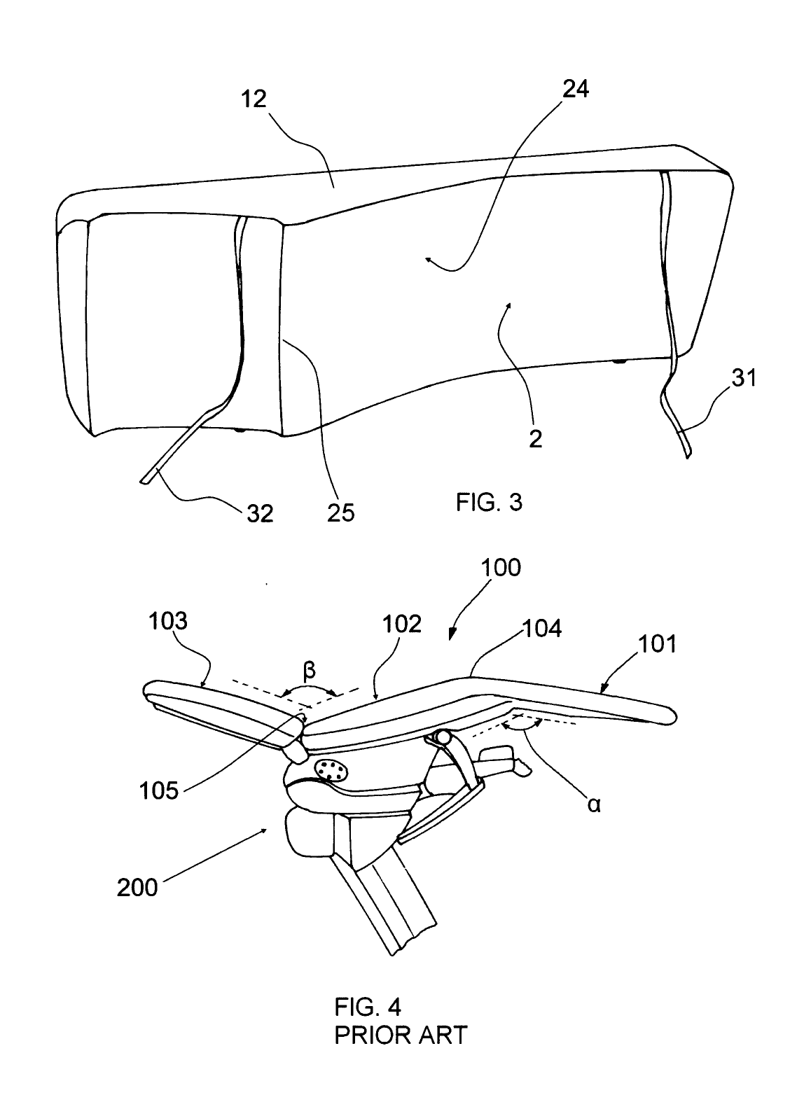

Mattress (1) comprises upper flat surface (13) and lower surface (2) (FIG. 3) with suitably curved profile to adapt to curvature of dental chair (100), so that upper surface of mattress is disposed according to a horizontal plane, converting dental chair (100) into a surgery couch.

Upper surface (13) has rectangular dimensions typical of surgery couch, for example 2 m×0.5 m.

In particular, lower surface (2) of mattress comprises convex portion (25), shaped as downward-protruding bump, which is disposed in said recessed concave portion (105) between seat (102) and back rest (103) of dental chair (FIG. 1).

Moreover, lower surface (2) of mattress provides for concave portion (105) disposed above curved portion (104) connecting seat (102) and leg rest (101) of dental chair.

Therefore, lower surface (2) of mattress comprises:
first portion (21) extending from first transversal edge (10) to concave portion (24);
second portion (22) extending from concave portion (24) to convex portion (25); and
third portion (23) extending from convex portion (25) to second transversal edge (11).

The first portion (21) of lower surface of mattress is parallel or slightly inclined with respect to upper surface (13) of mattress with slightly increasing thickness from concave portion (24) to first transversal edge (10).

Second portion (22) of lower surface of mattress is inclined with respect to first portion (21) by obtuse angle (α) of approximately 140°-160°.

Third portion (23) of lower surface of mattress is inclined with respect to second portion (22) by obtuse angle (β) of approximately 140°-160°. Preferably angle (α) is identical to angle (β).

Transversal edges (10, 11) of mattress are basically flat with thickness of approximately 15-30 cm, so that mattress can be positioned vertically on ground with minimum overall dimensions.

Belts (31 , 32) are connected to mattress (1) in order to be firmly fixed to dental chair (100). Belts (31, 32) are provided with suitable buckles for closing and tensioning. A first belt (31) is disposed in correspondence of first portion (21) of lower surface of mattress to tie round foot rest (101) of dental chair. A second belt (32) is disposed in correspondence of third portion (23) of lower surface of mattress to tie round back rest (103) of dental chair, in proximity of part connecting with seat (102).

For illustrative, not limiting purposes, mattress (1) comprises padding and external coating. Padding can be obtained from molding foamed material, such as polyurethane foam. External coating can be, for instance, poly latex, leather or imitation leather.

Mattress (1) is provided with cushion (4) with low thickness, in such way to be folded and rolled up, as shown in FIG. 2. Cushion is provided with Velcro (40) to be maintained in rolled-up configuration. Cushion (4) can be made from same material as mattress.

Numerous variations and modifications can be made to the present embodiment of the invention, within the each of experts of the field, while still falling within the scope of the invention as claimed in the attached claims.

1. An adapter mattress for a dental chair, comprising a flat upper surface and a lower surface with suitably cursed profile in order to adapt to a curvature of the dental chair, so that the upper surface of the mattress is disposed according to a horizontal plane, converting the dental chair into a surgery couch.

2. The adapter mattress of claim 1, wherein said dental chair comprises a seat, a back and a concave portion recessed between the seat and the back, wherein the lower surface of said adapter mattress comprise's a convex portion shaped as a downward-protruding bump, is is disposed in said recessed concave portion of the dental chair.

3. The adapter mattress of claim 1, wherein said dental chair comprises a seat, a leg rest and a curved convex portion connecting the seat and the leg rest, wherein the lower surface of said adapter mattress comprises a concave portion shaped as bump, which is disposed above said curved convex portion of the dental chair.

4. The adapter mattress of claim 3, wherein the lower surface of mattress comprises:
a first portion extending from a first transversal edge to the concave portion;
a second portion extending from the concave portion to a convex portion; and
a third portion extending from the convex portion to a second transversal.

5. The adapter mattress of claim 4, wherein the that portion of the lower surface of the mattress is slightly tilted with respect to the upper surface of the mattress with slightly increasing thickness from the concave portion to the first transversal edge.

6. The adapter mattress of claim 4, wherein the first portion of the lower surface of the mattress is parallel to the upper surface of the mattress.

7. The adapter mattress of claim 4, wherein the second portion of the lower surface of the mattress is tilted with respect to the first portion by obtuse angle (α) of approximately 140°-160°.

8. The adapter mattress of claim 4, wherein in the third portion of the lower surface of the mattress is tilted with respect to the second portion by obtuse angle (β) of approximately 140°-160°.

9. The adapter mattress of claim 1, wherein the adapter mattress comprises a first transversal edge and a second transversal edge that are substantially flat with thickness of 15-30 cm, so that the adapter mattress can be positioned vertically on the ground with minimum overall dimensions.

10. The adapter mattress claim 1, wherein the adapter mattress comprises belts connected to the adapter mattress in order to firmly fix the adapter mattress to the dental chair.
